(19) United States
(12) Patent Application Publication
(10) Pub. No.: US 2017/0122424 A1
(43) Pub. Date: May 4, 2017

(54) CAMSHAFT HAVING A CLOSING COVER

(71) Applicant: ThyssenKrupp Presta TecCenter AG, Eschen (LI)

(72) Inventors: Monika WEBER, Wangen (DE); Michael BOLD, Sevelen (CH); Reiner ALEY, Ilsenburg (DE); Mario ILGEROTH, Thale (DE)

(73) Assignee: THYSSENKRUPP PRESTA TECCENTER AG, Eschen (LI)

(21) Appl. No.: 15/312,565

(22) PCT Filed: Apr. 22, 2015
(86) PCT No.: PCT/EP2015/058681

§ 371 Date: Nov. 18, 2016

(30) Foreign Application Priority Data
May 26, 2014 (DE) 10 2014 007 591.5

(51) Int. Cl. F16H 53/02

(52) U.S. Cl. CPC F16H 53/025

(57) ABSTRACT

A hollow-cylindrical camshaft may include a closing cover and supply openings. Slipping of the closing cover may be prevented by indentations introduced into the camshaft. The indentations may be inwardly rolled portions, impressions, notches, or plastic deformations, for instance, introduced from the outside by punches or holding means that project into the interior of the camshaft. The indentations may be arranged in one or more planes orthogonal to an axial direction of the camshaft, wherein the indentations are rotationally symmetrical or can be arranged symmetrically or asymmetrically. The indentations can be mounted in the axial direction either between the closing cover and the supply opening located closest to the closing cover, or at the same axial positioning as the supply opening such that slipping of the closing cover over the supply opening is prevented.”

The invention relates to a camshaft, comprising a hollow shaft and a closing cover arranged in the interior of the hollow shaft.

Camshafts can be provided with radial bores through which oil can be conducted. A fitted closing cover in the interior of the camshaft ensures that oil does not penetrate into undesirable regions. When a closing cover is present, it is important that the latter does not slip during the operation of the camshaft. Slipping would firstly cause a change to the oil pressure conditions within the camshaft and secondly could clog up support bores or cut the latter off from the oil supply.

Hollow-cylindrical camshafts with a fitted closing cover are known from DE 100 00 916 A1 and DE 10 2006 036 850 A1.

It is the object of the present invention to modify a camshaft, consisting of a hollow shaft, without a large technical outlay and as flexibly as possible such that slipping of a fitted closing cover is prevented.

The object is achieved by a camshaft which comprises a hollow shaft, at least one cam and a closing cover arranged in the interior of the hollow shaft and at a distance from the cam in the axial direction being provided with one or more indentations in order to prevent slipping of the closing cover in at least one axial direction. The axial extent of the one or more indentations is smaller than or equal to the axial distance between an end of the closing cover that faces the cam and the cam. The indentations can be local deformations to the hollow shaft that are brought about from the outside, and also holding means which are mounted into the hollow shaft from the outside or inside, and which project into the interior of the hollow shaft and therefore locally constrict the cross section of the hollow shaft at the appropriate location.

The one or more indentations have the advantage that they can also not be introduced into the camshaft tube until the assembly process.

The camshaft, comprising a hollow shaft, comprises one or more supply openings in order to supply bearings and adjacent devices, for example a brake booster or a phaser, with oil. It is ensured by the introduction of one or more indentations in the camshaft that the supply openings introduced in the camshaft cannot be closed by slipping of the closing cover due to torsion, oil pressure or peripheral bending of the camshaft during the operation. Furthermore, by preventing the closing cover from slipping, the oil pressure within the camshaft is kept constant.

In an embodiment of the invention, the one or more indentations projecting into the interior of the camshaft are arranged as desired in one or more planes orthogonal to the axial direction of the camshaft, wherein at least one indentation is mounted in such a manner that the closing cover cannot slip into the closest supply opening, and therefore an oil supply through the supply openings is ensured. The one or more indentations can be arranged in the axial direction of the camshaft between the closing cover and the supply bore which is located closest to the closing cover, or can be mounted at the same axial positioning as the supply bore which is located closest to the closing cover. However, the one or the more indentations can also extend in the axial direction of the camshaft from the end of the closing cover until over the supply bore which is located closest to the closing cover, or can extend in the axial direction of the camshaft from the end of the closing cover as far as the axial position of the closest cam over the interior space of the camshaft, which interior space is located in between and in which the one or more supply bores are situated. The position of the indentations can be selected according to requirements and in accordance with the desired rotational behavior of the camshaft. An indentation radially encircling the hollow shaft at the same axial position as that of the supply bore is particularly advantageous, and therefore the supply bore is located within the encircling indentation. In this manner, the encircling indentation forms an oil transfer ring or an oil groove, by means of which a good oil supply or oil transfer can be ensured.

In order to prevent the closing cover from slipping in the interior of the camshaft, said closing cover, however, can also be wedged in by one or more indentations being in each case situated in the axial direction of the camshaft on both sides of the closing cover. In this manner, the closing cover is unable to move in any direction within the camshaft, as a result of which it is prevented that a slipping of the closing cover influences the size of the cavity bounded by the closing cover and therefore influences the oil pressure within the camshaft.

In an embodiment of the invention, the one or the more indentations are inwardly rolled portions which are impressed into the camshaft from the outside, or plastically inwardly molded portions, impressions or notches introduced by means of a punch. Indentations introduced into the camshaft from the outside have the decisive advantage that, in the case of the method for introducing the indentations, no soiling enters the hollow shaft and therefore the oil circuit. The indentations are preferably inwardly rolled portions radially encircling the hollow shaft. Such inwardly rolled portions have the particular advantage that when they formed at an axial position at which a supply bore is also situated, good oil transfer can be ensured. Furthermore, inwardly rolled portions are simple to realize since no expensive tools are required for the rolling-in operation.

In an embodiment of the invention, the one or the more indentations are holding means which project into the interior of the hollow shaft and are mounted fixedly with a means of connection. The holding means can be one or more holding means which are introduced through the outer wall of the camshaft from the outside through bores and project into the interior space of the hollow shaft, or one or more holding means which are mounted from the inside into the camshaft. The holding means are fastened in the camshaft by means of a means of connection. At this juncture, the term means of connection should be considered as being broadly defined. The means of connection may be, for example, welding, but also screwing, adhesive bonding or pressing in. By holding means being introduced from the inside or outside in the camshaft and projecting into the interior of the hollow shaft, the closing cover can be prevented from slipping without the outer shape of the camshaft being changed in this regard.

In an embodiment of the invention, the one or more indentations can be rotationally symmetrical, or can be arranged symmetrically or asymmetrically. A rotationally symmetrical arrangement is particularly advantageous here since this does not impair the rotational behavior of the camshaft.

The object according to the invention is likewise achieved by a mounting method for a camshaft, comprising a hollow shaft and a closing cover arranged in the interior of the hollow shaft, in which one or more indentations are introduced into the camshaft after the closing cover has been inserted into the camshaft. With this method, it is possible to install supply openings, closing covers and associated indentations, which prevent the slipping of the one or more closing covers at undesirable positions, into the camshaft in a flexible manner. The indentations, together with the introduction of the closing cover, can be produced in the machining of the hollow shaft, or in the mounting of the camshaft. Apart from a closing cover, other components which are located in the hollow shaft can also be retained by means of this mounting method.

In an embodiment of the mounting method, the one or the more indentations after the introduction into the camshaft have a defined minimum extent in the radial and axial direction and can be expanded retrospectively in both directions. The width and depth of the indentations can be expanded retrospectively depending on requirements.

In a mounting method for a camshaft, comprising a hollow shaft and a closing cover arranged in the interior of the hollow shaft, one or more indentations are rolled into the camshaft from the outside, or are molded, notched or impressed by means of a punch, in order to prevent the closing cover from slipping in at least one axial direction. The introduction of indentations into the camshaft from the outside, for example an encircling groove, does not introduce any soiling into the hollow shaft and therefore into the oil circuit.

In an embodiment of the mounting method, the one or the more indentations are introduced in a rotationally symmetrical manner into the camshaft from the outside. By means of the rotational symmetry of the inwardly rolled portion, plastic deformation, which is introduced by means of a punch, notching or impression, the rotational properties of the camshaft are maintained. In the mounting method, instead of an indentation pressed into the hollow shaft on one side, a constriction which extends over at least a part of the camshaft circumference, preferably in a completely encircling manner, is introduced. In the case of a completely encircling constriction of the hollow shaft, use can be made in the mounting method of a three-roller rolling apparatus having rollers which are offset by 120° and can either be driven or non-driven. In this case, either the roll head rotates about the hollow shaft or the hollow shaft rotates about its central axis while the rolls are stationary. The rolls are radially adjustable, and therefore a certain contour on the camshaft surface can be traveled along. By means of the adjustable rollers, a constriction is rolled into the hollow shaft, wherein the rolls are preferably brought up in a controlled manner such that they produce a constriction in the hollow shaft without reducing the wall thickness of the hollow shaft in the process. As a result of a three roller arrangement, the eccentricity at the constriction in the hollow shaft can also be improved, which is particularly advantageous in respect of using the constriction as an oil transfer point or oil bearing point. The use of a three roller arrangement makes it possible to reduce the process time of the mounting method by, for example, the rollers being adjusted differently radially. In addition, the action of force on the hollow shaft can be better compensated for with a three roller arrangement.

In a mounting method for a camshaft, comprising a hollow shaft and a closing cover arranged in the interior of the hollow shaft, in order to prevent the closing cover from slipping holding means are mounted into the camshaft by the holding means which project into the interior of the camshaft being let in through bores in the hollow shaft. By holding means being pushed and mounted or introduced into the interior of the camshaft through bores, the closing cover is prevented by the holding means from slipping and at the same time the surface of the outer wall of the camshaft does not change in its shape. The holding means introduced through bores can be material elevations, for example welding beads, in which molten material is introduced into the cavity of the camshaft. However, the introduction of molten material through a bore would have the disadvantage that the torsional rigidity of the camshaft is reduced by the bore. By contrast, introducing molten material through the end of the hollow shaft would not result in any reduction in the torsional rigidity. The molten material which is introduced can assume various shapes. It may be a single welding point or else a welding bead which, for example, has an extent completely encircling the inner side of the hollow shaft radially.

In a mounting method for a camshaft, comprising a hollow shaft and a closing cover arranged in the interior of the hollow shaft, holding means are mounted into the hollow shaft from the inside in order to prevent the closing cover from slipping in at least one axial direction, wherein the holding means are fastened in the hollow shaft by means of a means of connection. By holding means being fastened in the interior of the camshaft by means of a means of connection, the closing cover is prevented by the holding means from slipping and at the same time the surface of the outer wall of the camshaft is not changed in its shape.

In an embodiment of the mounting method, the holding means are fastened in the interior of the camshaft by means of adhesive bonding, screwing or welding.

The advantage of the invention is that it is possible to introduce the one or the more indentations, which prevent the closing cover from slipping in the camshaft, into the camshaft tube during the mounting process. In this manner, supply bores, closing covers and associated indentations which prevent the one or more closing covers from slipping at undesirable positions can be installed in the camshaft in a flexible manner.

The invention is explained in more detail below with reference to device sketches, wherein these are merely exemplary embodiments. In the sketches:

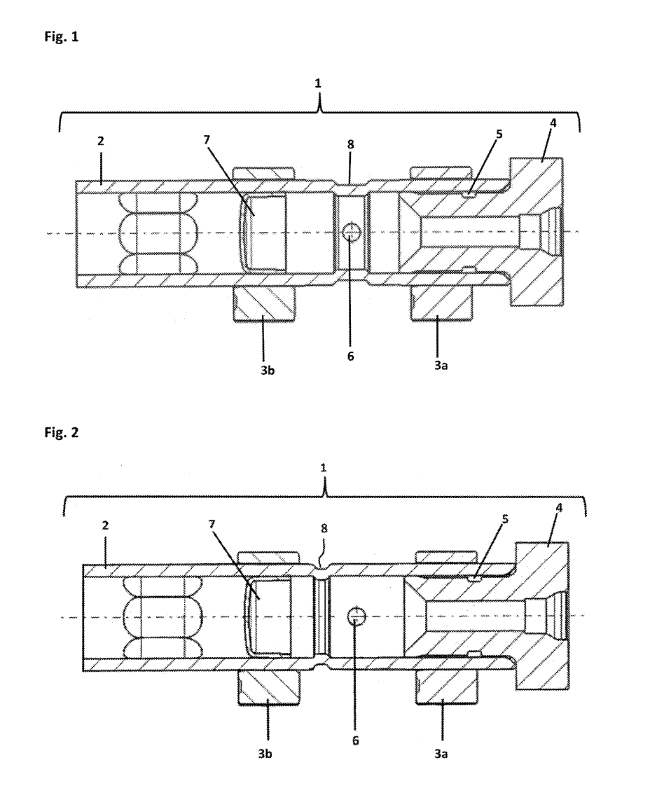

FIG. 1 shows a diagram of a camshaft with a rotationally symmetrical inwardly rolled portion at the same axial position as the supply opening,

FIG. 2: shows a diagram of a camshaft with a rotationally symmetrical inwardly rolled portion which is located in the axial direction between the end of the closing cover and the supply opening,

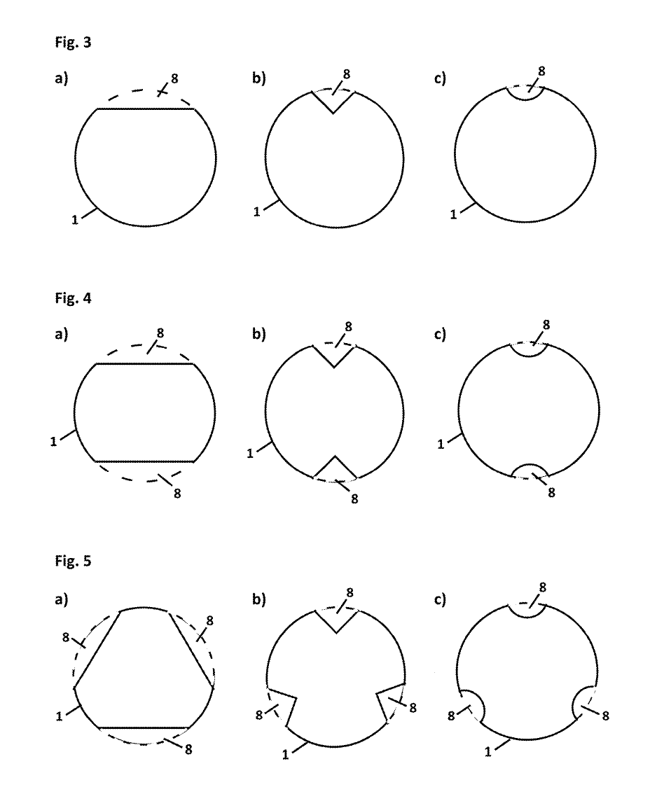

FIG. 3: shows cross sections of a camshaft at an axial position of the merely one indentation, wherein FIG. 3a) is an inwardly rolled portion, FIG. 3b is a notch and FIG. 3c) is an impression.

FIG. 4: shows cross sections of a camshaft at an axial position of the mirror-symmetrical indentation which consists of two indentations, wherein FIG. 4a) involves inwardly rolled portions, FIG. 4b) involves notches and FIG. 4c) involves impressions.

FIG. 5: shows cross sections of a camshaft at an axial position of the asymmetric indentation which consists of three indentations, wherein FIG. 5a) involves inwardly rolled portions, FIG. 5b) involves notches and FIG. 5c) involves impressions.

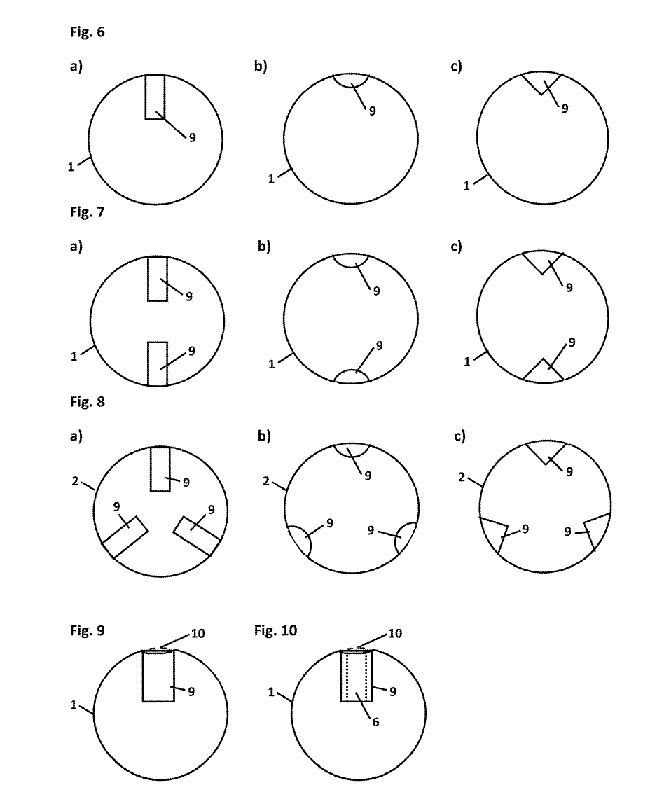

FIG. 6: shows cross sections of a camshaft at an axial position at which a holding means is mounted in the camshaft from the inside. The presented forms of the holding means are merely examples.

FIG. 7: shows cross sections of a camshaft at an axial position at which two holding means are mounted mirror-symmetrically from the inside in the camshaft. The presented forms of the holding means are merely examples.

FIG. 8: shows cross sections of a camshaft at an axial position at which three holding means are mounted asymmetrically from the inside in the camshaft. The presented forms of the holding means are merely examples.

FIG. 9: shows a cross section of a camshaft at an axial position at which a holding means is introduced from the outside through a bore in the camshaft wall and projects into the interior of the camshaft, wherein the holding means consists of a solid cylinder. The presented form of the holding means is merely an example.

FIG. 10: shows a cross section of a camshaft at an axial position at which a holding means is introduced from the outside through a bore in the camshaft wall, which holding means projects into the interior of the camshaft, wherein the holding means consists of a hollow cylinder. The presented form of the holding means is merely an example.

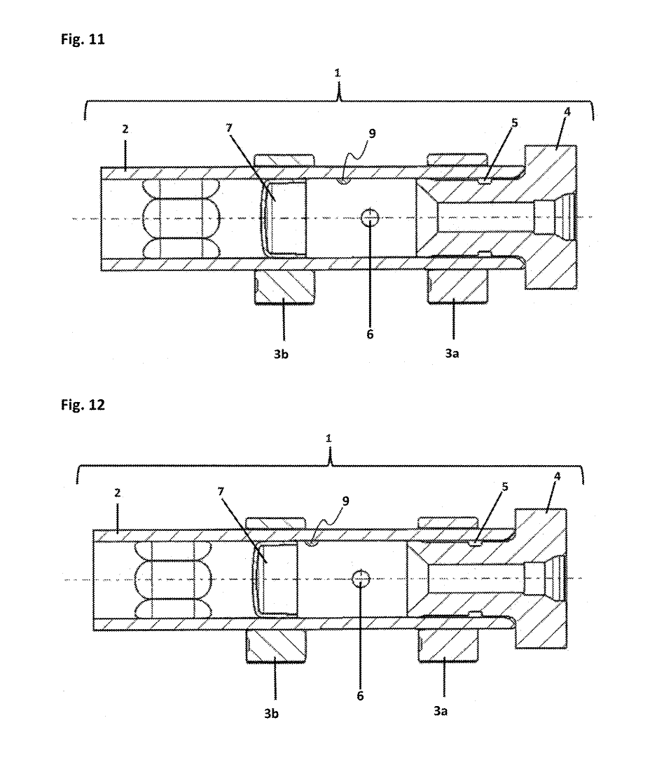

FIG. 11: shows a diagram of a camshaft with a material elevation at an axial position centrally between the closing cover and the supply opening.

FIG. 12: shows a diagram of a camshaft with a material elevation at an axial position just next to the closing cover, between the closing cover and the supply opening.

FIG. 1 shows a camshaft 1 consisting of a hollow shaft 2 which is fitted with cams 3a and 3b and is closed with an endpiece 4 which is provided with an annular seal 5. The camshaft 1 is provided with a supply opening 6 through which adjacent bearings and devices are supplied with oil. In order to prevent oil from penetrating into undesirable regions, a closing cover 7 is located in the camshaft. In the example illustrated, the closing cover 7 has been pressed under a cam 3b and is therefore constricted in the hollow shaft 2. The closing cover 7 is spaced apart axially from the cam 3a. So that the closing cover 7 does not slip during operation and thus clogs up the supply opening 6, an indentation 8 in the form an inwardly rolled portion, which prevents the closing cover 7 from slipping, is situated in the hollow shaft 2. In this example, the indentation 8 in the form of an inwardly rolled portion is rotationally symmetrical and is situated at the same axial position as the supply bore 6. Therefore the cross section of the hollow shaft is locally constricted at the corresponding location. The axial extent of the indentation 8 is smaller than the axial distance between an end of the closing cover 7, which end faces the cam 3a, and the cam 3a.

FIG. 2 shows a camshaft 1 which is constructed similarly to that which is illustrated in FIG. 1. The device sketches from FIG. 1 and FIG. 2 differ insofar as the indentation 8 which in this example corresponds to a rotationally symmetrically inwardly rolled portion is located between the end of the closing cover and the supply opening 6.

FIG. 3 shows three examples of cross sections of camshafts 1, comprising a hollow shaft 2, at the axial position on which an indentation 8 is situated. The indentation can be a plastic inwardly molded portion which is produced by means of a punch, a notch or an impression. FIG. 3a) shows an indentation in the form of a single punched inwardly molded portion, FIG. 3b) shows an indentation in the form of a single notch, and FIG. 3b) shows an indentation in the form of a single impression.

FIG. 4 shows three examples of cross sections of camshafts 1, comprising a hollow shaft 2, at the axial position of which a mirror-symmetrical indentation 8 is situated. The indentation can be a plastic inwardly molded portion which is produced by means of a punch, a notch or an impression. FIG. 4a) shows an indentation in the form of two opposite punched-in inwardly molded portions, FIG. 4b) shows an indentation in the form of two opposite notches, and FIG. 4c) shows an indentation in the form of two opposite impressions.

FIG. 5 shows three examples of cross sections of camshafts 1, comprising a hollow shaft 2, at the axial position on which an asymmetrical indentation 8 is situated. The indentation can be a plastic inwardly molded portion which is produced by means of a punch, a notch or an impression. FIG. 5a) shows an indentation in the form of three punched-in inwardly molded portions, FIG. 5b) shows an indentation in the form of three notches, and FIG. 5c) shows an indentation in the form of three impressions.

FIG. 6 shows three examples of cross sections of camshafts, comprising a hollow shaft 2, at the axial position on which an indentation 8 in the form of a single holding means 9 mounted into the hollow shaft 2 from the inside is situated. FIG. 6a) to FIG. 6c) show illustrative forms of a holding means mounted in the interior of the hollow shaft.

FIG. 7 shows three examples of cross sections of camshafts, comprising a hollow shaft 2, at the axial position on which a mirror-symmetrical indentation 8 in the form of two opposite holding means 9, which are mounted into the hollow shaft 2 from the inside, is situated. FIG. 7a) to FIG. 7c) show illustrative forms of a holding means mounted in the interior of the hollow shaft.

FIG. 8 shows three examples of cross sections of camshafts 1, comprising a hollow shaft 2, at the axial position on which an asymmetrical indentation 8 in the form of three holding means 9 mounted into the hollow shaft 2 from the inside is situated. FIG. 8a) to FIG. 8c) show illustrative forms of a holding means mounted in the interior of the hollow shaft.

FIG. 9 shows the cross section of a camshaft 1 at an axial position at which a holding means 9 is introduced from the outside through a bore 10 in the camshaft wall and projects into the interior of the camshaft 1. In the example shown, the holding means 9 is a solid cylinder. The presented form of the holding means is merely an example.

FIG. 10 shows the cross section of a camshaft 1 at an axial position at which a holding means 9 is introduced from the outside through a bore 10 in the camshaft wall and projects into the interior of the camshaft 1. In the example shown, the holding means 9 is a hollowed-out cylinder which serves as a supply opening 6. The presented form of the holding means is merely an example.

FIG. 11 shows a camshaft 1, consisting of a hollow shaft 2 which is fitted with cams 3a and 3b, and is closed with an end piece 4 which is provided with an annular seal 5. The camshaft 1 is provided with a supply opening 6 through which adjacent bearings and devices are supplied with oil. In order to prevent oil from penetrating into undesirable regions, there is a closing cover 7 in the camshaft. In the example illustrated, the closing cover 7 has been pressed under a cam 3b and therefore constricted in the hollow shaft 2. The closing cover 7 is spaced apart axially from the cam 3a. So that the closing cover 7 does not slip in operation and thus clog up the supply opening 6, an indentation 8 in the form of a holding means 9, which is formed by a material elevation, such as, for example, a welding bead, is situated in the hollow shaft 2. In this example, the material elevation has been introduced from the end of the hollow shaft and is situated centrally in the axial direction between the closing cover 7 and the supply opening 6 closest from the closing cover. The axial extent of the indentation 9 is smaller than the axial distance between an end of the closing cover 7 that faces the cam 3a and the cam 3a.

FIG. 12 shows a camshaft 1, consisting of a hollow shaft 2, which is fitted with cams 3a and 3b, and is closed with an endpiece 4 which is provided with an annular seal 5. The camshaft 1 is provided with a supply opening 6 through which adjacent bearings and devices are supplied with oil. In order to prevent oil from penetrating into undesirable regions, there is a closing cover 7 in the camshaft. In the example illustrated, the closing cover 7 has been pressed under a cam 3b and therefore constricted in the hollow shaft 2. The closing cover 7 is spaced apart axially from the cam 3a. So that the closing cover 7 does not slip in operation and thus clog up the supply opening 6, an indentation 8 in the form of a holding means 9, which is formed by a material elevation, such as, for example, a welding bead, is situated in the hollow shaft 2. In this example, the material elevation has been introduced from the end of the hollow shaft and is situated in the axial direction between the closing cover 7 and the supply opening 6 closest from the closing cover, right next to the closing cover 7. The axial extent of the indentation 9 is smaller than the axial distance between an end of the closing cover 7 that faces the cam 3a and the cam 3a.

### REFERENCE SIGNS

1 Camshaft

2 Hollow shaft

3a, 3b Cam

4 Endpiece

5 Annular seal

6 Supply opening

7 Closing cover

8 Indentation

9 Holding means

10 Bore

1.-18. (canceled)

19. A camshaft comprising:
a hollow shaft that includes an indentation and extends along an axis;
a cam disposed on the hollow shaft; and
a closing cover that is disposed in an interior of the hollow shaft and is spaced apart in an axial direction from the cam, wherein the indentation prevents the closing cover from slipping along the axial direction, with an axial extent of the indentation being smaller than or equal to an axial distance between the cam and an end of the closing cover that faces the cam.

20. The camshaft of claim 19 wherein the hollow shaft comprises at least one supply opening.

21. The camshaft of claim 20 wherein the indentation of the hollow shaft is disposed axially between the closing cover and the at least one supply opening closest to the closing cover.

22. The camshaft of claim 20 wherein the indentation extends in the axial direction from the end of the closing cover at least through the at least one supply opening closest to the closing cover.

23. The camshaft of claim 20 wherein the indentation extends in the axial direction from the end of the closing cover as far as the cam and over the interior of the hollow shaft between the end of the closing cover and the cam, where the at least one supply opening is disposed.

24. The camshaft of claim 20 wherein the indentation is a first indentation, the camshaft further comprising a second indentation on the hollow shaft, wherein the first indentation is disposed axially on a first side of the closing cover and the second indentation is disposed axially on a second side of the closing cover opposite the first side.

25. The camshaft of claim 20 wherein the indentation is disposed at a same axial position along the hollow shaft as the at least one supply opening closest to the closing cover.

26. The camshaft of claim 25 wherein the indentation is an inwardly rolled portion that is impressed into the hollow shaft from outside the hollow shaft.

27. The camshaft of claim 25 wherein the indentation is an impression that is impressed into the hollow shaft from outside the hollow shaft.

28. The camshaft of claim 25 wherein the indentation is a notch that is impressed into the hollow shaft from outside the hollow shaft.

29. The camshaft of claim 25 wherein the indentation is a plastic inwardly-molded portion that is punched into the hollow shaft from outside the hollow shaft.

30. The camshaft of claim 25 wherein the indentation is a holding means introduced through an outer wall of the hollow shaft from an outside of the hollow shaft and projecting into the interior of the hollow shaft.

31. The camshaft of claim 25 wherein the indentation is a holding means mounted fixedly in the interior of the hollow shaft.

32. The camshaft of claim 31 wherein the holding means is an introduced material elevation.

33. A mounting method for a camshaft having a hollow shaft and a closing cover disposed in an interior of the hollow shaft, the method comprising:
inserting the closing cover into the interior of the hollow shaft; and
introducing an indentation into the hollow shaft.

34. The mounting method of claim 33 wherein the indentation has a defined minimum extent in a radial direction and in an axial direction after being introduced into the hollow shaft, the mounting method further comprising expanding retrospectively the defined minimum extent of the indention in the radial direction and in the axial direction.

35. The mounting method of claim 33 further comprising introducing a molten material through an end of the hollow shaft.

36. A mounting method for a camshaft that includes a hollow shaft extending along an axis and a closing cover disposed in an interior of the hollow shaft, the method comprising rolling an indentation into the hollow shaft from an outside of the hollow shaft to prevent the closing cover from slipping in an axial direction.
